(19) United States
(12) Patent Application Publication
(10) Pub. No.: US 2014/0143040 A1
(43) Pub. Date: May 22, 2014

(54) MEMBERSHIP REGISTRATION SYSTEM AND MEMBERSHIP REGISTRATION METHOD

(71) Applicant: Yahoo Japan Corporation, Tokyo (JP)

(72) Inventors: Masamine TAKAHASHI, Tokyo (JP); Hidehito GOMI, Tokyo (JP)

(73) Assignee: Yahoo Japan Corporation, Tokyo (JP)

(21) Appl. No.: 14/067,336

(22) Filed: Oct. 30, 2013

(30) Foreign Application Priority Data
Nov. 22, 2012 (JP) 2012-256733

(51) Int. Cl. G06Q 30/02

(52) U.S. Cl. CPC G06Q 30/0226
USPC 705/14.27

(57) ABSTRACT

A membership registration system according to embodiments includes an information management apparatus and a store membership management apparatus. The information management apparatus receives user information from the terminal apparatus, and stores the user information in a user information storage unit. When the terminal apparatus makes a membership registration request, the store membership management apparatus transmits to the information management apparatus a transmission request of user information corresponding to a user of the terminal apparatus and sets the user information acquired from the information management apparatus in association with a member ID as member information in a store membership management storage unit.

### CROSS-REFERENCE TO RELATED APPLICATIONS

The present application claims priority to and incorporates by reference the entire contents of Japanese Patent Application No. 2012-256733 filed in Japan on Nov. 22, 2012.

### BACKGROUND OF THE INVENTION

1. Field of the Invention

The present invention relates to a membership registration system and a membership registration method.

2. Description of the Related Art

As a method for promoting sales in a store, offering member services such as a point service and a stamp service has conventionally been known. For example, a user who will be a member of such a membership service enters user information such as name and gender in a ledger or the like of a store, and the store side issues a membership card such as a point card or a stamp card.

The store side needs to work on the registration of the user information in a membership database when issuing the membership card, which is troublesome. Hence, Japanese Laid-open Patent Publication No. 2007-148696 proposes a technology that enables membership registration by inputting user information in a point input terminal.

However, if a user does not input information in the point input terminal in the technology, his/her membership is not registered, which is burdensome to the user, and the sales promotion of the store may not be able to be fully achieved.

### SUMMARY OF THE INVENTION

According to the exemplary embodiment, a membership registration system includes an information management apparatus and a store membership management apparatus. The information management apparatus includes a storage processing unit configured to store user information in a user information storage unit, and a transmission unit configured to transmit, when the store membership management apparatus requests transmission of user information, the user information according to the transmission request to the store membership management apparatus. The store membership management apparatus includes a store membership management storage unit configured to store member information of a membership service offered by a store, and a setting unit configured to transmit, when the terminal apparatus requests membership registration of a user, a transmission request of user information corresponding to the user of a terminal apparatus to the information management apparatus, and to set the user information acquired from the information management apparatus in association with a member ID as member information in the store membership storage unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an explanatory diagram of a membership registration process according to a first embodiment;

FIG. 2 is a diagram illustrating a configuration example of a membership registration system according to the first embodiment;

FIG. 3 is a diagram illustrating an example of a user information table;

FIG. 4 is a diagram illustrating an example of a member data table;

FIG. 5 is a diagram illustrating an example of setting data of a membership card app;

FIGS. 6A to 6D are diagrams illustrating examples of display screens of the membership card app;

FIG. 7 is a diagram illustrating a process flow of an information management apparatus according to the first embodiment;

FIG. 8 is a diagram illustrating a process flow of a store membership management apparatus according to the first embodiment;

FIG. 9 is an explanatory diagram of a membership registration process according to a second embodiment;

FIG. 10 is a diagram illustrating a configuration example of a membership registration system according to the second embodiment;

FIG. 11 is a diagram illustrating a process flow of a store membership management apparatus according to the second embodiment; and

FIG. 12 is an explanatory diagram of the membership registration process according to the second embodiment.

### DETAILED DESCRIPTION OF THE PREFERRED EMBODIMENTS

Hereinafter, embodiments of a membership registration system and a membership registration method according to the present application will be described in detail with reference to the drawings. The membership registration system and the membership registration method according to the present application are not limited by the embodiments. Moreover, a database will be described as “DB” below.

### 1. First Embodiment

1.1 Membership Registration Process

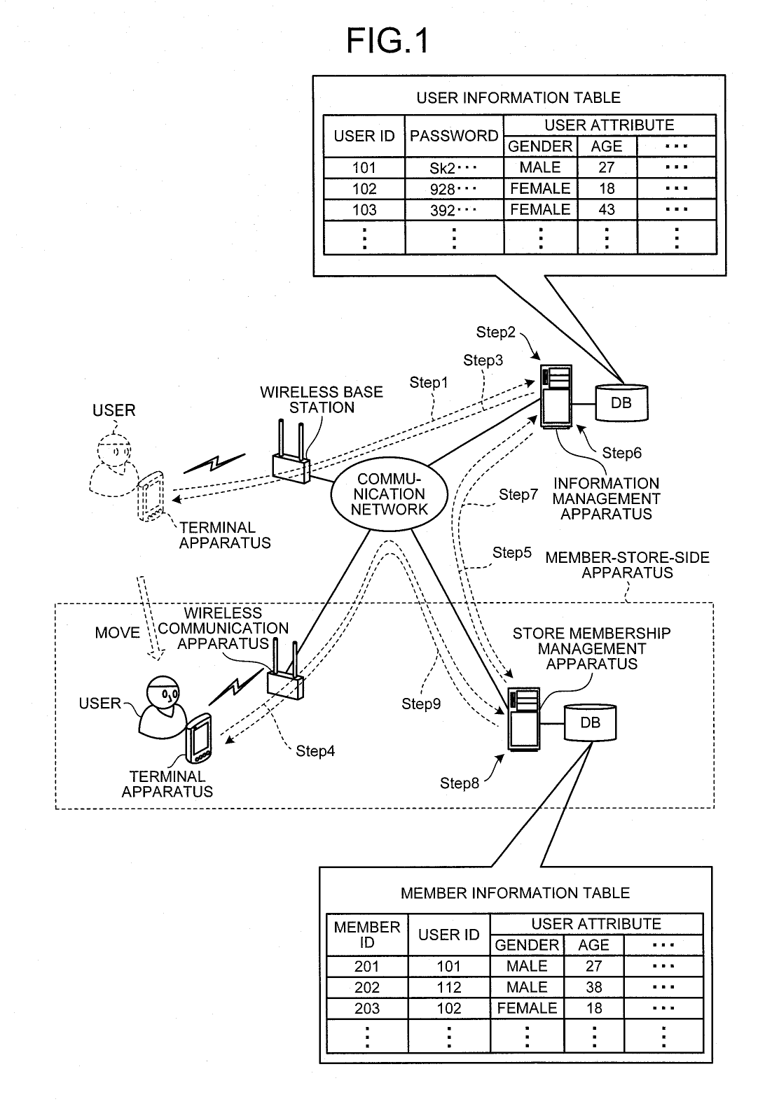

Firstly, a membership registration process according to a first embodiment will be described. FIG. 1 is an explanatory diagram of the membership registration process according to the first embodiment. The membership registration process offers a membership registration service. A store that joins the membership registration service will be described as a member store below.

In the membership registration process according to the embodiment, a user of a terminal apparatus registers his/her user information in an information management apparatus and accordingly can easily gain membership in a membership service offered by a member store of the membership registration service when the user of the wireless terminal comes to the member store.

As illustrated in FIG. 1, the membership registration system according to the first embodiment includes the terminal apparatus, the information management apparatus, and a member-store-side apparatus. Moreover, the member-store-side apparatus includes a wireless communication apparatus and a store membership management apparatus. The terminal apparatus, the information management apparatus, and the member-store-side apparatus are connected to each other via a communication network. The communication network is, for example, an IP (Internet Protocol) network such as the Internet.

A program of a membership card application (hereinafter described as the “membership card app”) as a dedicated application is installed in the terminal apparatus. The wireless terminal acquires program data of the membership card app provided from the information management apparatus via the communication network and loads the program data into its internal storage unit. Accordingly, the membership card app can be made to be executed.

Firstly, a user of the terminal apparatus executes the membership card app to perform user registration on the information management apparatus (Step 1). Specifically, the user of the terminal apparatus activates the membership card app in the terminal apparatus, inputs user information being information on the user, and then performs the operation of a registration instruction. Accordingly, a user registration request is transmitted from the terminal apparatus to the information management apparatus via a wireless base station. If a user ID and password of the user of the terminal apparatus is already set in the information management apparatus, the user of the terminal apparatus inputs the user ID and password, and performs the operation of the registration instruction. Accordingly, the user registration request is transmitted from the terminal apparatus to the information management apparatus in response to the operation.

The terminal apparatus is a wireless terminal that can communicate wirelessly and is, for example, a smartphone that can perform wireless LAN (Local Area Network) communication and public data communication. The user of the terminal apparatus transmits the user registration request to the information management apparatus by using these communication functions.

For example, if the wireless base station is a public data communication base station, the terminal apparatus transmits the user registration request by the public data communication function. If the wireless base station is a wireless LAN router or a wireless LAN access point, the terminal apparatus transmits the user registration request by the wireless LAN function.

If receiving the user registration request, the information management apparatus performs user registration (Step 2). Specifically, the information management apparatus issues and allocates a new user ID and password to the user of the terminal apparatus that has transmitted the user registration request without the user ID and password. The user registration request transmitted from the terminal apparatus includes the user information. The information management apparatus associates the user information included in the user registration request with the newly allocated user ID and password and sets the user information in a user information table of a user information DB. Moreover, an authentication process on whether or not the user ID and password included in the user registration request is set in the user information table of the user information DB is performed on the user of the terminal apparatus that has transmitted the user registration request including the user ID and password.

The information management apparatus notifies the terminal apparatus of the completion of the registration via the wireless base station (Step 3). Specifically, a user registration completion notice including the newly allocated user ID is transmitted to the terminal apparatus that has transmitted the user registration request without the user ID and password. If receiving the newly allocated user ID, the terminal apparatus stores the received user ID as setting data in the internal storage unit by the function of the membership card app. It can also be included in the user registration completion notice.

On the other hand, a user authentication completion notice including the authenticated user ID is transmitted to the terminal apparatus that has transmitted the user registration request including the user ID and password. If receiving the user authentication completion notice, the terminal apparatus can also store the user ID included in the user authentication completion notice as the setting data in the internal storage unit by the function of the membership card app.

The user of the terminal apparatus subsequently moves and enters the member store of the membership registration service. The wireless communication apparatus is placed in the member store. The wireless communication apparatus is, for example, a wireless LAN access point or an NFC (Near Field Communication) device. The wireless LAN is, for example, a wireless LAN specified by IEEE 802.11, and NFC includes, for example, Felica and ISO/IEC 14443 (MIFARE). The communication in NFC is not limited to radio waves, but can also use, for example, infrared communication, visible light communication, and sound waves.

When the terminal apparatus enters a communication area of the wireless communication apparatus placed in the premises of the member store, if the membership card app of the terminal apparatus is active, the terminal apparatus transmits a membership registration request including the user ID to the store membership management apparatus via the wireless communication apparatus (Step 4). The user ID included in the membership registration request is the user ID allocated by the information management apparatus to the user of the terminal apparatus.

Moreover, even if the membership card app of the terminal apparatus is not active, when the terminal apparatus enters the communication area of the wireless communication apparatus and subsequently the user of the terminal activates the membership card app, the terminal apparatus transmits a membership registration request including the user ID to the store membership management apparatus via the wireless communication apparatus.

In this manner, if the terminal apparatus is in the communication area of the wireless communication apparatus, the membership registration request is transmitted by the membership card app of the terminal apparatus. However, the terminal apparatus can be set to transmit a membership registration request by the function of the membership card app only if the wireless communication apparatus is a predetermined wireless communication apparatus. The terminal apparatus determines whether or not the wireless communication apparatus is the predetermined wireless communication apparatus, for example, based on identification information of the wireless communication apparatus.

With the function of the membership card app, the terminal apparatus transmits a membership registration request including the user ID to the store membership management apparatus in which the membership is not set. Therefore, the membership registration request is not transmitted to the store membership management apparatus in which the membership is seta In other words, the terminal apparatus does not transmit a membership registration request to the store membership management apparatus, the internal storage unit of which a member ID is stored as the setting data.

If receiving the membership registration request from the terminal apparatus, the store membership management apparatus transmits to the information management apparatus a user information request that requests user information corresponding to the user of the terminal apparatus that has transmitted the membership registration request (Step 5). The user information request includes the user ID allocated by the information management apparatus to the user of the terminal apparatus.

If receiving the user information request from the store membership management apparatus, the information management apparatus extracts from the user information table of the user information DB the user information corresponding to the user ID included in the user information request (Step 6), and transmits the extracted user information to the store membership management apparatus (Step 7).

If acquiring the user information from the information management apparatus, the store membership management apparatus associates the user information and the user ID acquired from the terminal apparatus with a newly allocated member ID and registers them as member information of the membership service in a member information table of a membership DB (Step 8). The store membership management apparatus then transmits a membership registration notice being a notice to the effect that the membership has been registered to the terminal apparatus via the wireless communication apparatus (Step 9). The store membership management apparatus can also cause a membership card issuance apparatus placed in the store to issue a membership card by transmitting the newly allocated member ID to the membership card issuance apparatus.

In this manner, in the membership registration system according to the embodiment, the user of the terminal apparatus is registered as a member of the membership service by the user of the terminal apparatus performing user registration on the information management apparatus and subsequently entering the communication area of the wireless communication apparatus placed in the premises of the member store. Hence, the process of application for membership in the membership service can be performed without the time and trouble of the user. Moreover, the store side does not need either to manually register the user information in the membership DB.

In the above description, the user registration request is set to be transmitted from the terminal apparatus via the wireless base station. However, the user registration request may be transmitted from the terminal apparatus to the information management apparatus via a wired communication network. Moreover, the store membership management apparatus may be placed in the premises of the member store. If the member store is a chain store, the store membership management apparatus may be placed in headquarters of the chain.

Hereinafter, a specific configuration and the content of a specific process of the membership registration system that executes the membership registration process will be described with reference to the drawings.

1.2 Configuration of Membership Registration System

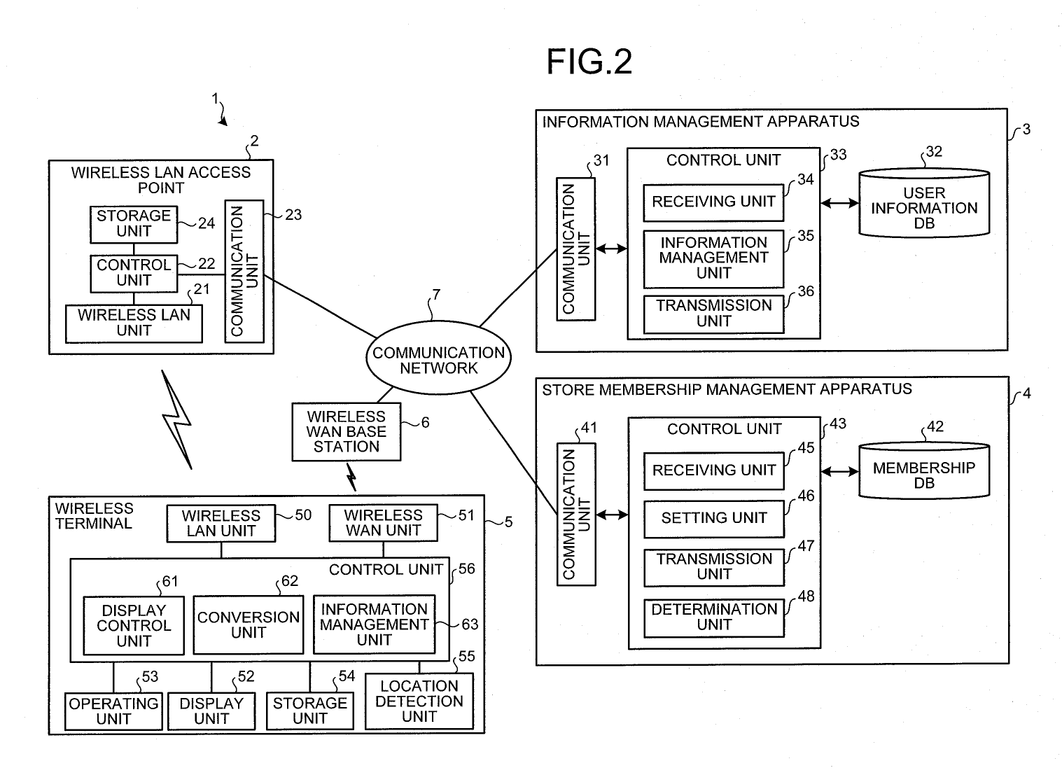

A configuration example of the membership registration system according to the first embodiment will be described using FIG. 2. FIG. 2 is a diagram illustrating a configuration example of the membership registration system according to the first embodiment. A description will be given below taking a wireless terminal that communicates wirelessly as an example of the terminal apparatus, and a wireless LAN access point as an example of the communication apparatus. A “member” below indicates a user of the wireless terminal that enjoys the service offered by the member store.

As illustrated in FIG. 2, a membership registration system 1 includes a wireless LAN access point 2, an information management apparatus 3, and a store membership management apparatus 4. The wireless LAN access point 2 is an example of the wireless communication apparatus. The store membership management apparatus 4 is an example of the store membership management apparatus. The membership registration system 1 executes on a user of a wireless terminal 5 the process of application for membership in a membership service offered by a member store being a store where the wireless LAN access point 2 is placed.

The membership service is a service offered to the user of the wireless terminal 5 whose member information is registered in a member data table, which is described below. The membership services include various services such as a point service, a stamp scheme, and a discount scheme. However, the point service will be described below. The stamp scheme is a scheme to offer, for example, a premium or a discount coupon if the number of stamps provided from a store side reaches a predetermined number. Moreover, the discount scheme is a scheme to discount goods and services provided.

The wireless terminal 5 is a mobile phone having a wireless LAN communication function, such as a smartphone, and can communicate between the wireless LAN access point 2 and a wireless WAN base station 6. In the example illustrated in FIG. 2, only one wireless terminal 5 is illustrated, but the wireless terminal 5 is owned by each user. Moreover, if the wireless communication apparatus placed in the member store is an NFC device, the wireless terminal 5 is a terminal apparatus equipped with an NFC function.

The store membership management apparatuses 4 are respectively provided for membership services offered by member stores. For example, the store membership management apparatus 4 is provided for each scheme such as a loyalty program offered by an appliance retailer or a stamp scheme offered by a clothing retailer. Moreover, if a member store is a chain store, the store membership management apparatus 4 may be provided for each chain store. Moreover, if one membership service is offered to a group of member stores of different business types, the store membership management apparatus 4 may be provided to the group.

The wireless LAN access point 2 and the store membership management apparatus 4 are managed by, for example, a manager of a store. The information management apparatus 3 is managed by, for example, a company to provide information services. The store membership management apparatus 4 and the information management apparatus 3 may be managed by a company to provide information services.

1.2.1 Wireless LAN Access Point 2

Firstly, the wireless LAN access point 2 will be described. The wireless LAN access point 2 includes a wireless LAN unit 21, a control unit 22, a communication unit 23, and a storage unit 24 as illustrated in FIG. 2. The wireless LAN unit 21 transmits and receives information to and from the wireless terminal 5 equipped with the wireless LAN communication function. The communication unit 23 transmits and receives information to and from a communication network 7.

The control unit 22 controls the entire wireless LAN access point 2 and executes an information relay process and the like. The information relay process is, for example, a process of transmitting information acquired from the wireless terminal 5 via the wireless LAN unit 21 from the communication unit 23 to the information management apparatus 3 and the store membership management apparatus 4, and further transmitting information acquired from the information management apparatus 3 and the store membership management apparatus 4 via the communication unit 23 from the wireless LAN unit 21 to the wireless terminal 5.

1.2.2 Information Management Apparatus 3

Next, the information management apparatus 3 will be described. The information management apparatus 3 includes a communication unit 31, a user information DB 32, and a control unit 33 as illustrated in FIG. 2. Furthermore, the control unit 33 includes a receiving unit 34, an information management unit 35, and a transmission unit 36.

The communication unit 31 is an interface such as an NIC (Network Interface Card). The control unit 33 transmits and receives various pieces of information to and from the store membership management apparatus 4 and the wireless terminal 5 via the communication unit 31 and the communication network 7. The user information DB 32 is a storage device, for example, a hard disk, a semiconductor memory device such as RAM (Random Access Memory) or flash memory, or an optical disc. The user information DB 32 stores a user information table for recording the information of a user as described below.

The control unit 33 is realized by an integrated circuit such as an ASIC (Application Specific Integrated Circuit) or an FPGA (Field Programmable Gate Array). Moreover, a CPU (Central Processing Unit) or an MPU (Micro Processing Unit) executes programs stored in an internal storage device using RAM as a workspace and accordingly the control unit 33 functions as the receiving unit 34, the information management unit 35, and the transmission unit 36. The configuration of the control unit 33 is not limited to such a configuration but may be another configuration as long as it is a configuration that performs information processing, which is described below.

The receiving unit 34 receives requests from the store membership management apparatus 4 and the wireless terminal 5 via the communication network 7. The request from the wireless terminal 5 is the user registration request as described above, and includes user information on the user of the wireless terminal 5 or the user ID and password. Moreover, the request from the store membership management apparatus 4 is the user information request as described above, and includes the user ID.

The information management unit 35 sets and updates the user information table. For example, if the receiving unit 34 receives the user registration request from the wireless terminal 5, the information management unit 35 issues a new user ID and password and sets in the user information table user information included in the user registration request with the user ID and password.

Moreover, if the user registration request received by the receiving unit 34 includes the user ID and password, the information management unit 35 performs the authentication process whether or not the user ID and password are set in the user information table. The information management unit 35 determines that authentication was successful if the user ID and password are set in the user information table.

Also if the user of the wireless terminal 5 makes a user registration request including a user ID selected by the user from a terminal apparatus other than the wireless terminal 5, the information management unit 35 accepts the user registration request. In this case, only if the user ID selected by the user is not set in the user information table, the information management unit 35 authenticates and issues the user ID selected by the user and sets the user ID together with the password included in the user registration request in the user information table.

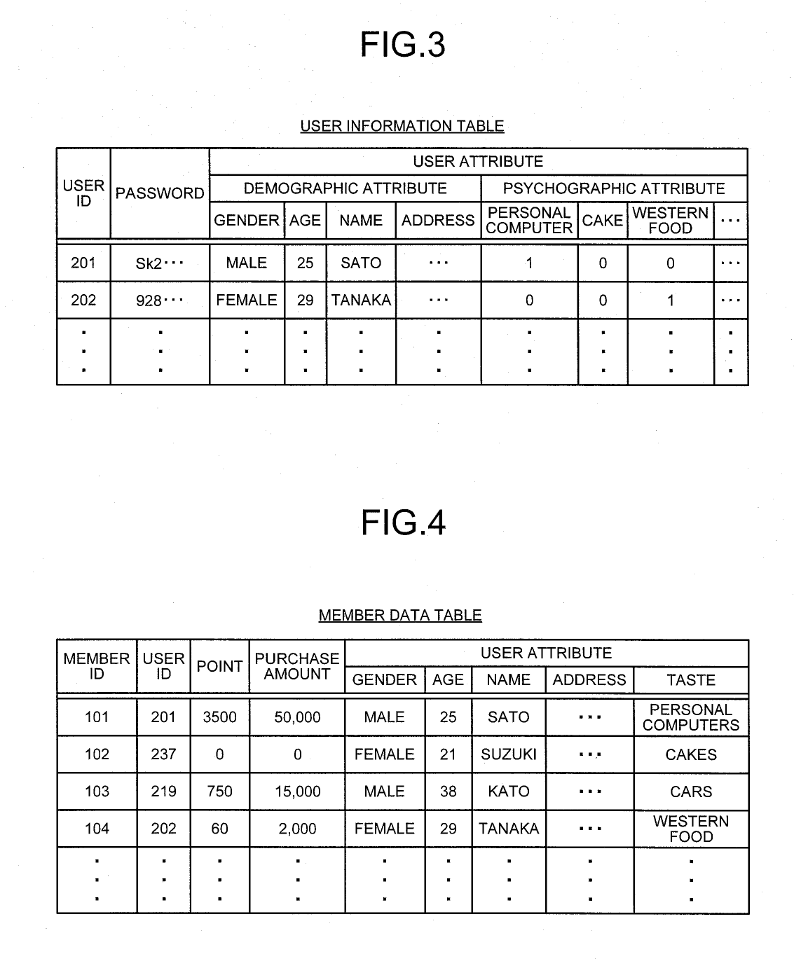

FIG. 3 is a diagram illustrating an example of the user information table stored in the user information DB 32. As illustrated in FIG. 3, the user information table includes information where a “password” and “user information” are associated for each “user ID.”

The “user ID” is a unique ID allocated to each user of the wireless terminals 5 and, for example, if the wireless terminal 5 registers a user with the information management apparatus 3, is allocated by the information management unit 35 and associated with the user information to be set in the user information table. The “password” is information for authentication and is allocated by the user or the information management unit 35.

If the user information table is not a table dedicated to the membership card app but is a member data table of another network service, which is described below, a terminal apparatus other than the wireless terminal 5 may register the user with the information management apparatus 3. In this case, the user ID is specified by the user of the wireless terminal 5 on the condition that the user ID is not a duplicate user ID that is already set in the user information table, and authorized and issued by the information management unit 35.

The “user information” is information on the user attributes of the wireless terminal 5 (hereinafter described as the attribute information in some cases) and includes information on “demographic attributes” and information on “psychographic attributes.” The “demographic attributes” are demographic attributes and are classified into the “gender,” “age,” “name,” “address,” and the like of a user. In the example illustrated in FIG. 3, the gender, age, name, and address of users are described as examples, but the demographic attributes are not limited to them, but various classification types such as the job, family structure, annual income, educational background, and the like of a user can be set as the “demographic attributes.”

The “psychographic attributes” are information indicating the sense of values, lifestyle, personality, taste, and the like of a user. The “psychographic attributes” here are classified into “personal computers,” “cakes,” “western food” as illustrated in FIG. 3. In the example illustrated in FIG. 3, “1” is associated when the taste of a user is relatively high, and “0” in the other cases for each classification. However, the scale is not limited to this, but, for example, the taste of a user may be assessed on a scale of 1 to 3 or more. Moreover, various changes can also be made for the classification types.

The user information table illustrated in FIG. 3 is described assuming to be a user information table for the membership card app, but the user information table is not limited to the table for the membership card app. For example, the user information table may be a user information table of another network service such as SNS (social networking service), a music distribution service, a video distribution service, a network gaming service, portal site service, or a search service.

In a case of the user information table of another network service, for example, with regard to the “psychographic attributes” of the user information illustrated in FIG. 3, the information management unit 35 can analyze the taste and the like of the user in accordance with the content of the use of the network service, and set and update the user information table. For example, in a case of the user information table of a search service, the information management unit 35 can analyze the taste and the like by the content of searches by the user of the wireless terminal 5 and update the “psychographic attributes.” Also in this case, the information management unit 35 can set and update the “demographic attributes” of the user information illustrated in FIG. 3 with the user information included in the user registration request.

The transmission unit 36 transmits to the wireless terminal 5 a user registration completion notice including a user ID newly allocated by the information management unit 35 to the terminal apparatus that has transmitted the user registration request without a user ID and password. Moreover, the transmission unit 36 transmits a user authentication completion notice including the user ID authenticated by the information management unit 35, to the terminal apparatus that has transmitted the user registration request including the user ID and password.

Moreover, the transmission unit 36 performs a process of extracting attribute information from the user information table and transmitting the attribute information. For example, if the receiving unit 34 receives the user information request from the information management apparatus 3, the transmission unit 36 extracts from the user information table attribute information related to the user ID included in the user information request and transmits the attribute information to the store membership management apparatus 4 via the communication network 7.

For example, if the user ID included in the user information request is “201,” the transmission unit 36 extracts attribute information corresponding to the user ID “201” from the user information table, and transmits the attribute information to the store membership management apparatus 4.

The program data of the membership card app is also stored in the user information DB 32. If the wireless terminal 5 makes a membership card app transmission request, the transmission unit 36 acquires the program data of the membership card app from the user information DB 32 and transmits the program data to the wireless terminal 5 via the communication network 7. The program data of the membership card app may be distributed from a program distribution apparatus different from the information management apparatus 3 to the wireless terminal 5.

In this manner, the control unit 33 of the information management apparatus 3 sets the user information transmitted from the wireless terminal 5 in the user information table, and transmits the user information set in the user information table at the request of the store membership management apparatus 4.

1.2.3 Store Membership Management Apparatus 4

The store membership management apparatus 4 includes a communication unit 41, a membership DB 42, and a control unit 43 as illustrated in FIG. 2. Furthermore, the control unit 43 includes a receiving unit 45, a setting unit 46, a transmission unit 47, and a determination unit 48.

The communication unit 41 is an interface such as an NIC. The control unit 43 transmits and receives various pieces of information to and from the wireless LAN access point 2, the information management apparatus 3, and the wireless terminal 5 via the communication unit 41.

The membership DB 42 is a storage device, for example, a hard disk, a semiconductor memory device such as RAM or flash memory, or an optical disc. Member information of users who are members of the membership service offered by a member store is stored in the membership DB 42.

FIG. 4 is a diagram illustrating an example of a member data table stored in the membership DB 42. As illustrated in FIG. 4, the member data table includes information where pieces of information such as a “user ID,” “points,” a “purchase amount,” “user attributes,” and the like are associated for each “member ID.”

The “points” are allotted, for example, when a user purchases goods and services of a member store, and a predetermined rate of points to a purchase amount of goods and services is allotted. For example, if a user of a member ID “104” purchases a product that costs “2,000 yen,” “60” being three percent of the product purchase amount is allotted as points as illustrated in FIG. 4.

Such an allotment of points is transmitted from an unillustrated store terminal connected to the communication network 7 to the store membership management apparatus 4 by inputting the member ID and the purchase amount in the store terminal and is set by the setting unit 46, which is described below, in the member data table.

As described below, the wireless terminal 5 can convert the member ID included in the setting data into a barcode by the function of the membership card app and display the member ID on a display unit 52. The barcoded member ID is input by a barcode reader connected to the store terminal. If the wireless terminal 5 can transmit the member ID in NFC, the member ID is received by an NFC device connected to the store terminal and can also be set in the member data table.

The “purchase amount” is information updated when a user purchases the goods and services of a member store, and indicates the total purchase amount of the goods and services for each member. For example, in the example illustrated in FIG. 4, a user with a member ID “101” purchased a total of “50,000 yen” of goods and services. The purchase amount is set and updated by the setting unit 46, which is described below, in the member data table by inputting the member ID and the purchase amount in the unillustrated store terminal as described above.

The “user attributes” are information indicating the user attributes of a member, and is information on gender, age, name, address and taste in the example illustrated in FIG. 4. Information indicating a user's sense of values, lifestyle, personality, and the like may be included in the “user attributes.”

The control unit 43 is realized by an integrated circuit such as an ASIC or an FPGA. Moreover, a CPU or an MPU executes programs stored in an internal storage device using RAM as a workspace and accordingly the control unit 43 functions as the receiving unit 45, the setting unit 46, the transmission unit 47, and the determination unit 48. The configuration of the control unit 43 is not limited to such a configuration but may be another configuration as long as it is a configuration that performs information processing, which is described below.

The receiving unit 45 receives information transmitted from the information management apparatus 3 and the wireless terminal 5 via the communication network 7. For example, the receiving unit 45 receives the membership registration request transmitted from the wireless terminal 5 via the communication unit 41, and further receives the user information transmitted from the information management apparatus 3 via the communication unit 41.

If the receiving unit 45 receives the membership registration request from the wireless terminal 5, the setting unit 46 registers information of the user of the wireless terminal 5 as member information of the membership service in the member data table of the membership DB 42. The membership registration request includes the user ID, and the setting unit 46 requests attribute information corresponding to the user ID included the membership registration request, from the information management apparatus 3 via the communication unit 41 and the communication network 7. By request, the information management apparatus 3 acquires the attribute information corresponding to the user ID from the user information DB 32 and transmits the attribute information to the store membership management apparatus 4.

If acquiring the attribute information of the user of the wireless terminal 5 from the information management apparatus 3, the setting unit 46 sets the acquired attribute information in the “user attributes” in the member data table. Moreover, the setting unit 46 allocates a new member ID to the user of the wireless terminal 5, and sets the allocated member ID, together with a terminal ID of the wireless terminal 5, in the member data table. Consequently, the “member ID,” the “user ID,” and the “user attributes” are set in the member data table. The process of the application for membership of the user of the wireless terminal 5 is complete.

Moreover, if acquiring information on the purchase amount and points associated with the member ID from the unillustrated store terminal connected to the communication network 7, the setting unit 46 updates the member data table based on the purchase amount and points.

The transmission unit 47 transmits information to the information management apparatus 3 and the wireless terminal 5 via the communication network 7. For example, if the process of the application for membership of the user of the wireless terminal 5 is completed by the setting unit 46, the transmission unit 47 issues an automatic membership registration notice to the wireless terminal 5 via the communication unit 41 and the wireless LAN access point 2. The automatic membership registration notice includes information indicating that the membership registration is complete, and the member ID. If acquiring the automatic membership registration notice, the wireless terminal 5 displays on the display unit 52 the information indicating that the membership registration is complete.

The determination unit 48 determines whether or not the membership registration request received by the receiving unit 45 from the wireless terminal 5 was made via the wireless LAN access point 2. Such a determination can be made based on, for example, an ID unique to the wireless LAN access point 2 (hereinafter described as the “AP-ID”).

For example, the control unit 22 of the wireless LAN access point 2 transmits a membership registration request from the wireless terminal 5 to the information management apparatus 3 including the AP-ID in the membership registration request. If the membership registration request includes the AP-ID, the determination unit 48 determines that the membership registration request was made via the wireless LAN access point 2. When the membership registration request transmitted from the wireless terminal 5 includes a store ID that identifies a store with which the membership is desired to be registered, if the store ID included in the membership registration request corresponds to the AP-ID, the determination unit 48 can also determine that the membership registration request was made via the wireless LAN access point 2.

Moreover, as described below, the wireless terminal 5 can also acquire the AP-ID transmitted from the wireless LAN access point 2 to the wireless terminal 5, and transmit the AP-ID to the store membership management apparatus 4 including the AP-ID in the membership registration request. Also in this case, if the membership registration request includes the AP-ID, the determination unit 48 determines that the membership registration request was made via the wireless LAN access point 2.

The setting unit 46 can also set the user information included in the membership registration request in the user information table only if the membership registration request is determined to have been made via the wireless LAN access point 2. In this case, if the membership registration request is determined to have not been made via the wireless LAN access point 2, the setting unit 46 transmits to the wireless terminal 5, for example, information to the effect that the membership registration request has not been permitted. By doing so, membership can be registered only from the wireless LAN access point 2 placed in the member store. Consequently, the membership registration process of the member store can be automatically performed for users who entered the member store. Therefore, the member store side can attract users who are willing to spend.

The store membership management apparatus 4 is provided for each membership service offered by a store. However, the store membership management apparatus 4 can be allocated to a plurality of membership services. In this case, the setting unit 46 sets a store ID, in addition to a member ID, user ID, and user attributes, in the member data table. Consequently, the membership service for the plurality of membership services can be easily constructed.

1.2.4 Wireless Terminal 5

As illustrated in FIG. 2, the wireless terminal 5 includes a wireless LAN unit 50, a wireless WAN unit 51, a display unit 52, an operating unit 53, a storage unit 54, a location detection unit 55, and a control unit 56. The wireless LAN unit 50 transmits and receives information to and from the wireless LAN access point 2. The wireless WAN unit 51 transmits and receives information to and from the wireless WAN base station 6. The wireless WAN base station 6 is, for example, a wireless base station of a public telephone communication network or a wireless base station of a public data communication network.

The display unit 52 is a touch panel display. The user of the wireless terminal 5 operates on a screen of the display unit 52 with the finger or the like, and accordingly can operate on an operation screen of the membership card app displayed on the display unit 52. The display unit 52 is, for example, a small LCD (Liquid Crystal Display) or organic EL display.

The operating unit 53 includes keys for inputting characters, numerals, and spaces, a keyboard including an enter key and an arrow key, and a power button.

The storage unit 54 is, for example, a semiconductor memory device such as RAM or flash memory, or a storage device such as a hard disk or an optical disc. Various programs, setting data, and the like are stored in the storage unit 54. The programs stored in the storage unit 54 include, for example, an OS (Operating System) and the membership card app program acquired from the information management apparatus 3.

The location detection unit 55 has a GPS (Global Positioning System) receiving function and acquires information on a current location of the wireless terminal 5. The current location information is latitude and longitude, but may be an address.

The control unit 56 is realized by an integrated circuit such as an ASIC or an FPGA. Moreover, for example, a CPU or MPU executes the programs stored in the storage unit 54 using unillustrated internal RAM as a workspace and accordingly the control unit 56 realizes or executes functions and effects of information processing, which is described below.

The control unit 56 executes the membership card app, the program data of which are stored in the storage unit 54, and accordingly functions as a display control unit 61, conversion unit 62, and an information management unit 63. Moreover, the control unit 56 executes the membership card app, the program data of which are stored in the storage unit 54, and accordingly stores the setting data of the membership card app in the storage unit 54. The configuration of the control unit 56 is not limited to such a configuration but may be another configuration as long as it is a configuration that performs information processing, which is described below.

The display control unit 61 creates a display image of the membership card app based on the setting data and layout data stored in the storage unit 54 and displays the display image on the display unit 52. The setting data include image data for creating a display screen and various pieces of ID information.

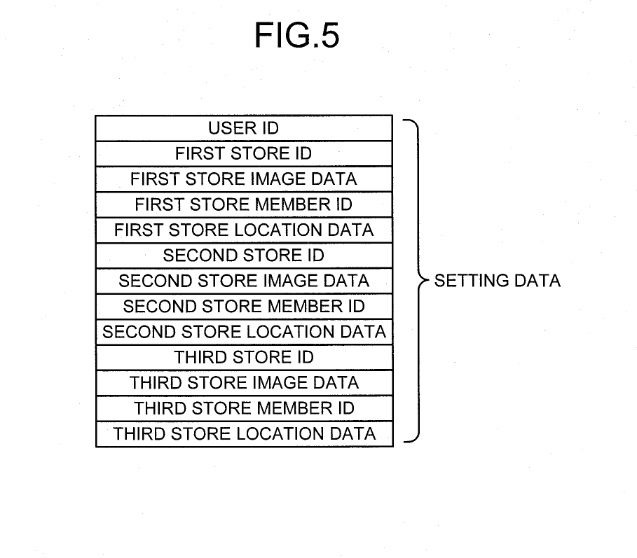

FIG. 5 is a diagram illustrating an example of the setting data. As illustrated in FIG. 5, the setting data include a user ID, a first store ID, first store image data, a first store member ID, first store location data, second store ID, second store image data, a second store member ID, second store location data, a third store ID, third store image data, a third store member ID, and third store location data.

The first store is a member store where the wireless LAN access point 2 illustrated in FIG. 2 is placed. Moreover, the second and third stores are also member stores where the wireless communication apparatuses are placed, but are omitted in FIG. 2. The first store location data include the location and address of the first store. The second store location data include the location and address of the second store. The third store location data include the location and address of the third store. The address is an address of the store membership management apparatus 4 corresponding to each store, and the wireless terminal 5 accesses the store membership management apparatus 4 based on the address. Although not illustrated, the setting data also include an address of the information management apparatus 3. The wireless terminal 5 accesses the information management apparatus 3 based on the address.

“0” is set as an initial value for the user ID, the first store member ID, the second store member ID, and the third store member ID. For example, information transmitted from the information management apparatus 3 and the store membership management apparatus 4 is set in the user ID and the first store member ID.

For example, if the information management apparatus 3 transmits a user registration completion notice including a user ID “202” to the wireless terminal 5 in response to the user registration request from the wireless terminal 5, the user ID of the setting data is “202.” Moreover, if the store membership management apparatus 4 transmits the member ID “101” in response to the membership registration request from the wireless terminal 5, the first store member ID of the setting data is “101.”

If the information management apparatus 3 transmits a user authentication completion notice to the wireless terminal 5 in response to the user registration request from the wireless terminal 5, the user ID included in the user registration request is set in the user ID of the setting data. If the information management apparatus 3 transmits a user authentication completion notice to the wireless terminal 5 in response to a user registration request including, for example, a user ID “212,” the user ID of the setting data is “212.”

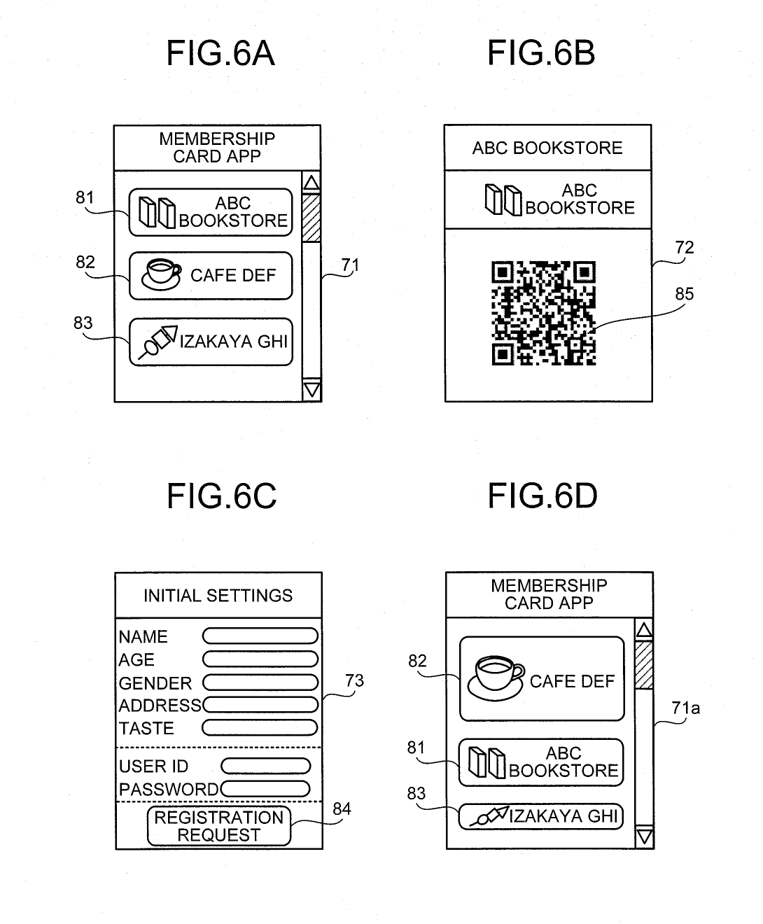

The display control unit 61 creates a display screen based on the setting data and layout data. FIGS. 6A to 6D are diagrams illustrating examples of display screens of the wireless terminal 5. FIG. 6A is a diagram illustrating an example of a “member store list display screen” of the membership card app.

Respective membership card images 81 to 83 of “ABC bookstore” being the first store, “Café DEF” being the second store, and “Izakaya GHI” being the third store are selectably displayed in a display screen 71 illustrated in FIG. 6A on the display unit 52. The membership card image 81 is created from the first store image data. The membership card image 82 is created from the second store image data. The membership card image 83 is created from the third store image data.

The conversion unit 62 performs a conversion process based on operation information output from the display unit 52. For example, it is assumed that the membership card image 81 is selected by user operation on the display unit 52 or the operating unit 53 in a state where the display screen 71 is displayed on the display unit 52. In this case, the conversion unit 62 reads a member ID corresponding to the membership card image 81 from the setting data stored in the storage unit 54 and converts the member ID into a two-dimensional barcode.

FIG. 6B is a diagram illustrating an example of a “member ID display screen” of the membership card app. The display control unit 61 displays on the display unit 52 a two-dimensional barcode 85 converted by the conversion unit 62 as in a display image 72 illustrated in FIG. 6B. The user of the wireless terminal 5 presents to the member store side the two-dimensional barcode 85 corresponding to the member ID displayed on the display unit 52 and accordingly can receive the membership service.

Moreover, if the user ID of the setting data stored in the storage unit 54 is “0” when the user activates the membership card app, the display control unit 61 displays a user attribute information input screen on the display unit 52 and prompts the user of the wireless terminal 5 to input attribute information. FIG. 6C is a diagram illustrating an example of the “user attribute information input screen” of the membership card app.

If the user inputs attribute information from the operating unit 53 in a state where a display screen 73 is displayed on the display unit 52 and a registration request button 84 is selected, the information management unit 63 transmits a user registration request including the input attribute information to the information management apparatus 3 via the wireless LAN unit 50. Moreover, if the user inputs a user ID and a password from the operating unit 53 in the state where the display screen 73 is displayed on the display unit 52 and the registration request button 84 is selected, the information management unit 63 transmits a user registration request including the input user ID and password to the information management apparatus 3 via the wireless LAN unit 50.

If the information management apparatus 3 transmits a user registration completion notice and a user authentication completion notice in response to the transmission of the user registration request, the information management unit 63 stores in the storage unit 54 the user ID included in the user registration completion notice and the user authentication completion notice as the setting data. If the user ID is not included in the user authentication completion notice, the information management unit 63 stores in the storage unit 54 the user ID included in the transmitted user registration request as the setting data. Moreover, if a member ID is transmitted from the store membership management apparatus 4, the information management unit 63 associates the member ID with its corresponding membership card image to store them as the setting data in the storage unit 54.

The setting data stored in the storage unit 54 include the first to third store location data as described above. The display control unit 61 can compare information on the current location of the wireless terminal 5 detected by the location detection unit 55 with the locations of the first to third stores and create a display screen.

For example, the display control unit 61 can change the display positions and sizes of the membership card images 81 to 83 in accordance with their distances from the current location of the wireless terminal 5. Moreover, the display control unit 61 can also change or flash the colors of the membership card images 81 to 83 in accordance with their distances from the current location of the wireless terminal 5.

For example, it is assumed that the second store is located closest to the current location of the wireless terminal 5, that the first store is located second closest, and that the third store is farthest. In this case, as illustrated in a display screen 71a of FIG. 6D, the membership card image 82 is the largest and is located at the top, and the membership card images 81 and 83 become smaller and are located lower in this order. By doing so, the user of the wireless terminal 5 can easily select the membership card image 82.

The information management unit 63 can also acquire the AP-ID transmitted from the wireless LAN access point 2 to the wireless terminal 5 and transmit the AP-ID to the store membership management apparatus 4 including the AP-ID in the membership registration request. For example, if the wireless LAN access point 2 periodically transmits a wireless packet called a beacon, the information management unit 63 acquires a BSSID (Basic Service Set Identifier) included in the beacon as the AP-ID, and transmits the BSSID to the store membership management apparatus 4 including the BSSID in the membership registration request.

Moreover, the information management unit 63 can transmit the membership registration request also if the AP-ID transmitted from the wireless LAN access point 2 to the wireless terminal 5 is the same as the store ID included in the setting data stored in the storage unit 54. By doing so, the wireless terminal 5 side can inform the information management apparatus 3 that it is the transmission of the membership registration request via the wireless communication apparatus of the member store. In this case, the information management apparatus 3 does not need to perform the process of determining whether or not the membership registration request was made via the wireless LAN access point 2.

Moreover, the information management unit 63 can also access the store membership management apparatus 4 via the wireless LAN access point 2 and acquire the store ID from the store membership management apparatus 4. If the store ID acquired from the store membership management apparatus 4 is the same as the store ID included in the setting data stored in the storage unit 54, the information management unit 63 transmits the membership registration request to the store membership management apparatus 4.

Moreover, the information management unit 63 can also access the information management apparatus 3 via the wireless LAN access point 2 and acquire a store ID transmitted from the information management apparatus 3. If the store ID acquired from the information management apparatus 3 is the same as a store ID included in the setting data stored in the storage unit 54, the information management unit 63 transmits a membership registration request to the store membership management apparatus 4. In this case, if access is made from the wireless terminal 5 via the wireless LAN access point 2, the control unit 33 of the information management apparatus 3 transmits to the wireless terminal 5 a store ID corresponding to the AP-ID of the wireless LAN access point 2. A store information table where the AP-ID and the store ID are associated is stored in the user information DB 32 of the information management apparatus 3. The control unit 33 of the information management apparatus 3 determines a store ID corresponding to the AP-ID of the wireless LAN access point 2 based on the store information table, and transmits the store ID to the wireless terminal 5.

Moreover, the information management unit 63 can also transmit to the store membership management apparatus 4 a store ID that identifies a store with which a user desires to register including the store ID in the membership registration request, in addition to the user ID. For example, it is assumed that the membership card image 81 is selected by a user operation on the display unit 52 or the operating unit 53 in the state where the display screen 71 illustrated in FIG. 6A is displayed on the display unit 52. In this case, if the first store member ID is “0,” the information management unit 63 accesses the store membership management apparatus 4 including the first store ID in the membership registration request based on the first store location data.

1.3 Process Flow of Membership Registration System 1

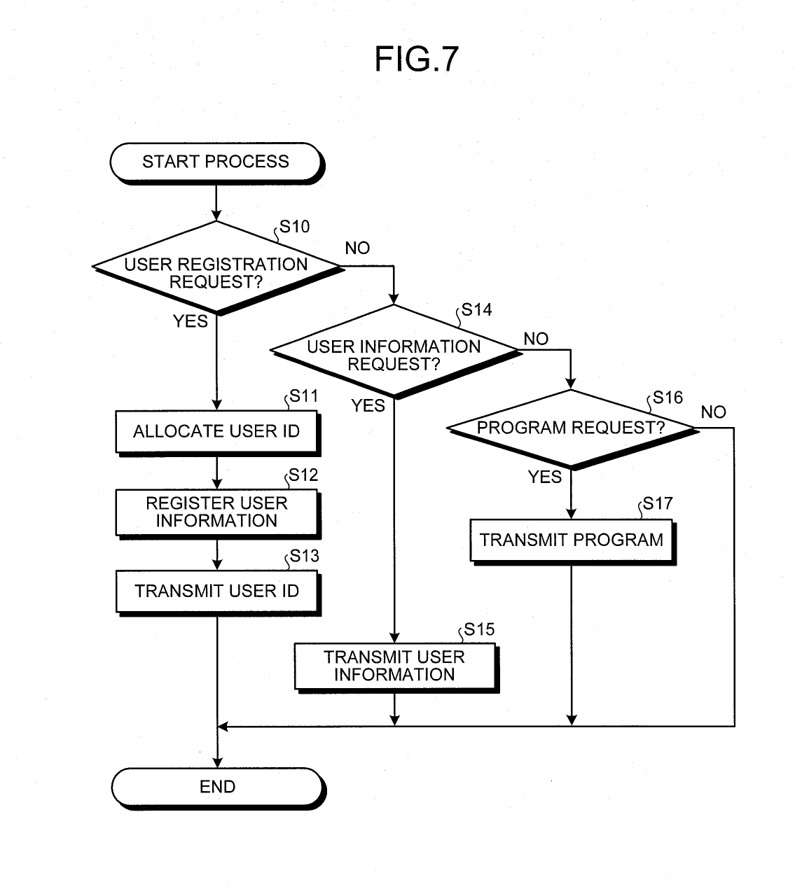

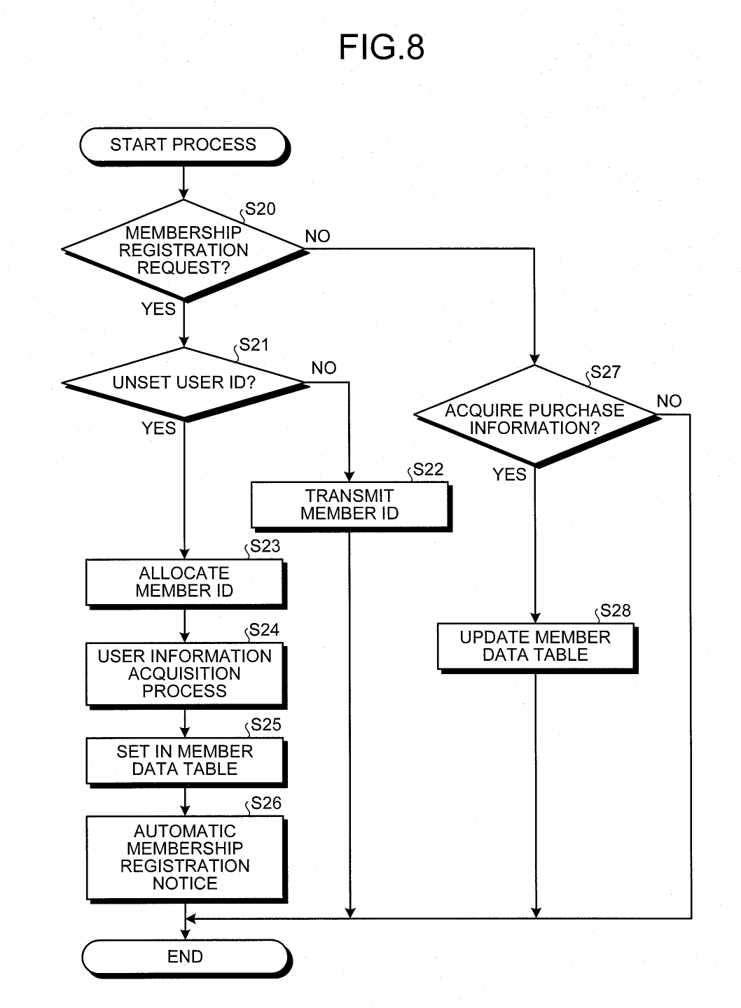

Next, a description will be given of a procedure for the membership registration process by the membership registration system 1 according to the first embodiment. FIG. 7 is a diagram illustrating a process flow of the information management apparatus 3 according to the first embodiment. FIG. 8 is a diagram illustrating a process flow of the store membership management apparatus 4 according to the first embodiment.

Firstly, the process flow of the information management apparatus 3 will be described. A description will be given below taking, as an example, a process of a case where the wireless terminal 5 transmits a user registration request without a user ID and password.

As illustrated in FIG. 7, the control unit 33 of the information management apparatus 3 determines whether or not to have received the user registration request from the wireless terminal 5 (Step S10). If determining to have received the user registration request (Step S10; Yes), the control unit 33 issues and allocates a new user ID (Step S11) and registers the user information (Step S12). The user information is registered by associating the user information included in the user registration request with the newly allocated user ID and setting them in the user information table.

When the registration of the user information is complete, the control unit 33 transmits the newly allocated user ID to the wireless terminal 5 that has requested the user registration (Step S13). The control unit 56 of the wireless terminal 5 stores in the storage unit 54 the user ID transmitted from the information management apparatus 3 as the setting data.

If determining to have not received the user registration request from the wireless terminal 5 in Step S10 (Step S10; No), the control unit 33 determines whether or not to have received a user information request from the store membership management apparatus 4 (Step S14). If determining to have received the user information request (Step S14; Yes), the control unit 33 extracts user information corresponding to a user ID included in the user information request from the user information table and transmits the user information to the store membership management apparatus 4 (Step S15).

If determining to have not received the user information request (Step S14; No), the control unit 33 determines whether or not to have received a program request from the wireless terminal 5 (Step S16). If determining to have received the program request (Step S16; Yes), the control unit 33 transmits to the wireless terminal 5 the program data of the membership card app stored in the membership DB 42 (Step S17).

If determining to have not received the program request (Step S16; No), or if the processes of Steps S13, S15, and S17 end, the control unit 33 ends the process. The processes of Steps S10 to S17 are repeatedly executed by the control unit 33.

Next, a process flow of the store membership management apparatus 4 will be described. As illustrated in FIG. 8, the control unit 43 of the store membership management apparatus 4 determines whether or not to have received from the wireless terminal 5 the membership registration request made via the wireless LAN access point 2 (Step S20). If determining to have received the membership registration request (Step S20; Yes), the control unit 43 determines whether or not the user ID included in the membership registration request is an unset user ID (Step S21). The unset user ID is a user ID whose user information is not set in the member data table.

If the user ID included in the membership registration request is not an unset user ID (Step S21; No), the control unit 43 transmits to the wireless terminal 5 a member ID set in the member data table in response to the membership registration request (Step S22). The wireless terminal 5 sets the member ID transmitted from the store membership management apparatus 4 as a member ID of a corresponding store in the setting data.

On the other hand, if the user ID included in the membership registration request is an unset user ID (Step S21; Yes), the control unit 43 allocates a new member ID to a user of the wireless terminal 5 (Step S23). Moreover, the control unit 43 requests and acquires user information corresponding to the user ID included in the membership registration request from the information management apparatus 3 (Step S24).

Next, the control unit 43 sets in the member data table the user ID included in the membership registration request, the user information acquired from the information management apparatus 3, and the member ID newly allocated in Step S23 as new member information (Step S25).

When the setting of the member information in the member data table is complete, an automatic membership registration notice is issued to the wireless terminal 5 (Step S26). The automatic membership registration notice includes the new member ID. The wireless terminal 5 sets in the setting data the new member ID included in the automatic membership registration notice as a member ID of a corresponding member store.

If determining to have not received the membership registration request in Step S20 (Step S20; No), the control unit 43 determines whether or not to have acquired purchase information from the unillustrated store terminal (Step S27). The purchase information transmitted from the store terminal includes a purchase amount and points, which are associated with the member ID. If determining to have acquired the purchase information (Step S27; Yes), the control unit 43 updates the member data table based on the acquired purchase amount and points (Step S28).

If determining to have not acquired the purchase information (Step S27; No), or the processes of Steps S22, S26, and S28 end, the control unit 43 ends the process. The processes of Steps S20 to S28 are repeatedly executed by the control unit 43.

### 2. Second Embodiment

Next, a membership registration process according to a second embodiment will be described. In the membership registration process according to the first embodiment, if the terminal apparatus makes a membership registration request, the store membership management apparatus 4 is set to allocate a member ID. However, the membership registration process according to the second embodiment is different in a point that member IDs of member stores (hereinafter referred to as unset member IDs) are preset in the setting data of the membership card app.

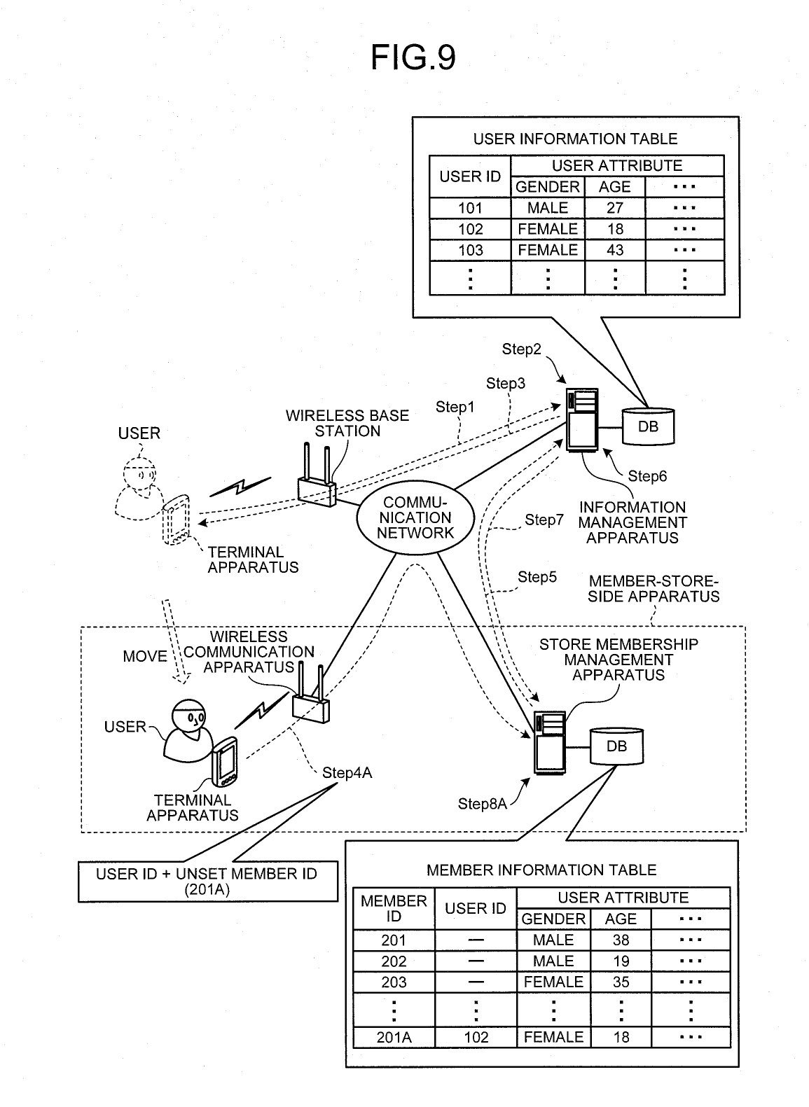

Firstly, the membership registration process according to the second embodiment will be described with reference to FIG. 9. FIG. 9 is an explanatory diagram of the membership registration process according to the second embodiment. The processes of Steps 1 to 3 and 5 to 7 illustrated in FIG. 9 are similar to the processes of Steps 1 to 3 and 5 to 7 illustrated in FIG. 1. Therefore, Steps 4A and 8A will be described here.

In Step 4A, the terminal apparatus transmits a membership registration request including a user ID and an unset member ID to the store membership management apparatus via the wireless communication apparatus placed in the premises of the member store. The unset member ID is included in advance in the setting data of the membership card app and, if there is a plurality of information management apparatuses, is a unique ID allocated to each information management apparatus.

Membership can also be registered from the unillustrated store terminal, and the unset member ID is an ID that permits the grasp of a route of the membership registration. In the example illustrated in FIG. 9, “201A” to which information “A” that can be distinguished from a member ID allocated by the membership registration from the store terminal is assigned is included as the unset member ID in the membership registration request.

In Step 8A, the store membership management apparatus associates the user ID and unset member ID included in the membership registration request with the user information acquired from the information management apparatus and sets them in the member information table. In this manner, the unset member ID is transmitted from the terminal apparatus and accordingly the store membership management apparatus does not need to allocate a new member ID and the burden of the process can be reduced. In addition, the unset member ID is an ID allocated in a distinguishable manner for each information management apparatus. Accordingly, it is possible to easily grasp that the user information has been acquired from which information management apparatus.

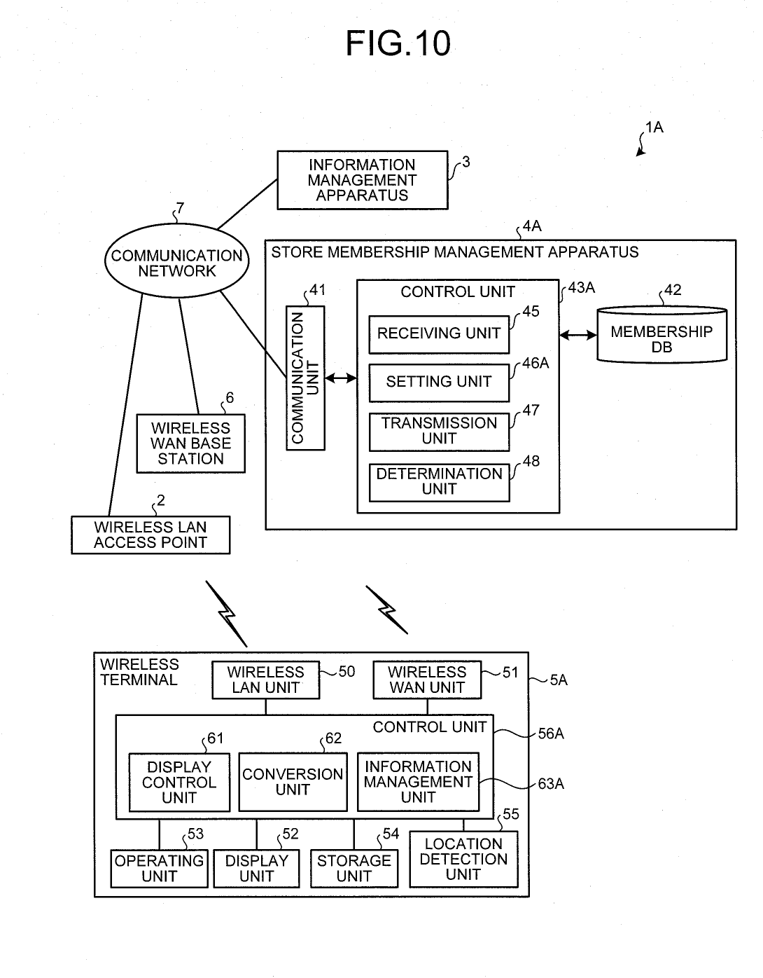

FIG. 10 is a diagram illustrating a configuration example of a membership registration system according to the second embodiment. A membership registration system 1A illustrated in FIG. 10 is different from the membership registration system illustrated in FIG. 2 in part of the processes of a store membership management apparatus 4A and a wireless terminal 5A. Reference numerals are assigned to components that performs similar processes to those of the membership registration system 1 illustrated in FIG. 2, similarly to the components of the membership registration system 1, and their descriptions will be omitted.

As illustrated in FIG. 10, the store membership management apparatus 4A includes the receiving unit 45, a setting unit 46A, the transmission unit 47, and the determination unit 48. If the receiving unit 45 receives a membership registration request from the wireless terminal 5, the setting unit 46A acquires user information from the information management apparatus 3 based on a user ID included in the membership registration request. The setting unit 46A then associates the user information acquired from the information management apparatus 3 with the user ID and an unset member ID, which are included in the membership registration request, sets them as new member information in the user information table of the membership DB 42, and accordingly completes the membership registration.

If the membership registration is complete, the store membership management apparatus 4 according to the first embodiment transmits a membership registration notice including a member ID to the wireless terminal 5. However, the store membership management apparatus 4A does not transmit a member ID. This is because a member ID set as member information is information transmitted from the wireless terminal 5A.

A control unit 56A of the wireless terminal 5A includes the display control unit 61, the conversion unit 62, and an information management unit 63A. The information management unit 63A makes a membership registration request including a user ID and unset member ID as described above. The unset member IDs are included in the setting data stored in the storage unit 54, respectively, for membership services of member stores, and are preset as the first to third store member IDs illustrated in FIG. 5.

For example, when transmitting the program data of the membership card app to the wireless terminal 5, the control unit 33 of the information management apparatus 3 includes information that an unset member ID is allocated to each member store as the setting data of the membership card app.

When the wireless terminal 5A enters the communication area of the wireless LAN access point 2, the information management unit 63A of the wireless terminal 5A transmits the membership registration request including the user ID and unset member ID to the store membership management apparatus 4A.

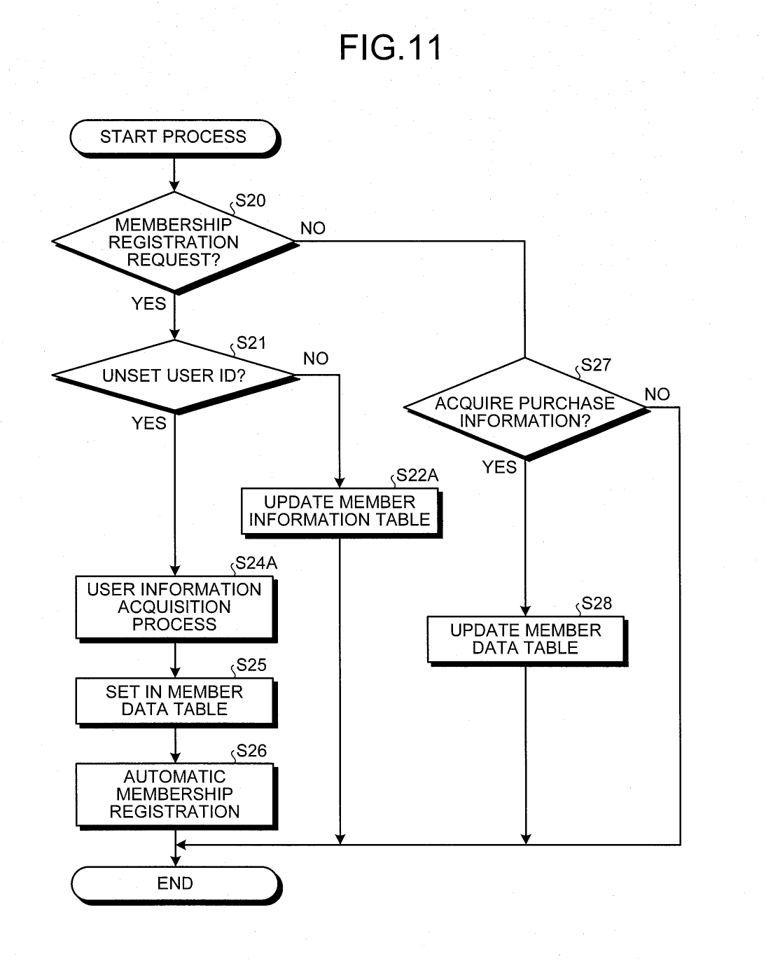

FIG. 11 is a diagram illustrating a process flow of the store membership management apparatus 4A. In FIG. 11, the processes of Steps S20, S21, and S25 to S28 are similar to the processes illustrated in FIG. 8. If the user ID included in the membership registration request is not an unset user ID (Step S21; No), the control unit 43A of the store membership management apparatus 4A updates the member information table (Step S22A).

Specifically, if the user ID included in the membership registration request is not an unset user ID, the user ID is associated with a member ID and user information, and the control unit 43A updates the member ID associated with the user ID to the unset member ID included in the membership registration request, in the member information table. Consequently, even if the membership card app is reinstalled in the wireless terminal 5A, the store membership management apparatus 4A can change member information without newly acquiring the user information from the information management apparatus 3.

Moreover, if the user ID included in the membership registration request is an unset user ID (Step S21; Yes), the control unit 43A does not allocate a new member ID, associates the user information acquired from the information management apparatus 3 with the user ID and unset member ID included in the membership registration request, and sets them as new member information in the user information table of the membership DB 42 (Step S24A).

As described above, the membership registration system 1A according to the second embodiment previously acquires an unset member ID on the terminal apparatus side and sets the unset member ID in the member information table. Accordingly, the process load of the store membership management apparatus 4A can be reduced.

When receiving the user registration request from the wireless terminal 5A, the control unit 33 of the information management apparatus 3 can also transmit information that the unset member ID, in addition to the user ID allocated to the request, is allocated to each member store as the setting data of the membership card app. At this point, the control unit 33 may associate the user ID and unset member ID with the user information and set them in the user information table.

By doing so, the control unit 43A of the store membership management apparatus 4A can acquire the user information from the information management apparatus 3 with the unset member ID as a key. If receiving the user information request including the unset member ID, the control unit 33 of the information management apparatus 3 extracts the user information associated with the unset member ID from the user information table and transmits the user information to the store membership management apparatus 4A.

### 3. Third Embodiment

Next, a membership registration system according to a third embodiment will be described. In the membership registration systems 1 and 1A according to the first and second embodiments, the store membership management apparatuses 4 and 4A are set to acquire user information from the information management apparatus 3 with a user ID as a key. However, in the membership registration system according to the third embodiment, the store membership registration apparatus acquires user information from the information management apparatus with a dummy user ID as a key.

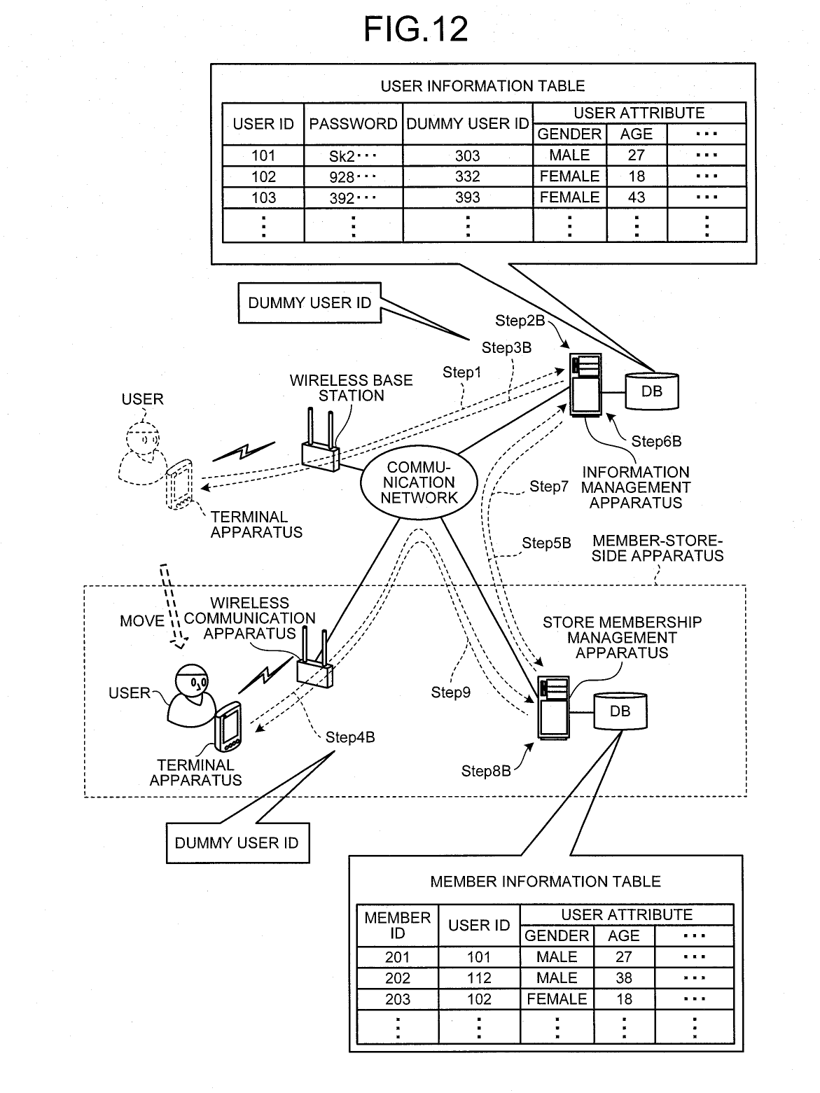

A membership registration process according to the third embodiment will be described with reference to FIG. 12. FIG. 12 is an explanatory diagram of the membership registration process according to the third embodiment. Steps 1, 7, and 9 illustrated in FIG. 12 are processes similar to Steps 1, 7, and 9 illustrated in FIG. 1.

The terminal apparatus executes the membership card app and accordingly transmits a user registration request to the information management apparatus first (Step 1). When receiving the user registration request, the information management apparatus performs user registration (Step 2B). Specifically, the information management apparatus issues and allocates a new user ID and dummy user ID to a user of the terminal apparatus.

The user registration request transmitted from the terminal apparatus includes user information. The information management apparatus associates the user information included in the user registration request with the newly allocated user ID and dummy user ID and sets them in the user information table of the user information DB.

The information management apparatus transmits the newly allocated dummy user ID to the terminal apparatus via the wireless base station (Step 3B). If receiving the newly allocated dummy user ID, the terminal apparatus stores the received dummy user ID as the setting data in the internal storage unit by the function of the membership card app.

The terminal apparatus transmits a membership registration request including the dummy user ID to the store membership management apparatus via the wireless communication apparatus placed in the premises of a member store (Step 4B). The dummy user ID included in the membership registration request is the dummy user ID allocated by the information management apparatus to the user of the terminal apparatus.

If receiving the membership registration request from the terminal apparatus, the store membership management apparatus transmits to the information management apparatus a user information request that requests the user information corresponding to the user of the terminal apparatus that has transmitted the membership registration request (Step 5B). The user information request includes the dummy user ID allocated by the information management apparatus to the user of the terminal apparatus.

If receiving the user information request from the store membership management apparatus, the information management apparatus extracts from the user information table of the user information DB the user information corresponding to the dummy user ID included in the user information request (Step 6B), and transmits the extracted user information to the store membership management apparatus (Step 7).

If acquiring the user information from the information management apparatus, the store membership management apparatus associates the user information and the dummy user ID acquired from the terminal apparatus with a newly allocated member ID and registers them as member information of the membership service in the membership DB (Step 8B). The store membership management apparatus then transmits a membership registration notice being a notice to the effect that the membership has been registered to the terminal apparatus via the wireless communication apparatus (Step 9).

In this manner, an ID that the store membership management apparatus transmits and receives to and from the terminal apparatus and the information management apparatus is not a user ID but a dummy user ID. Accordingly, it becomes possible to register membership without allowing the member store side that manages the store membership management apparatus to know the user ID managed by the information management apparatus.

Therefore, even if the user information table of the information management apparatus is not dedicated to the membership card app but is also used in common to the user management of another network service and the user ID is used for the user authentication of the other network service, it is possible to provide the user information to the store membership management apparatus while maintaining the confidentiality of the user ID. The dummy user ID is an ID that can be used only for the user identification process to provide user attribute information to a member store. Accordingly, even if the dummy user ID is leaked illegitimately, there is no risk of an illegitimate login to the other service and illegitimate rewriting of the user information and damage to the user can be reduced to a minimum. The user information transmitted from the information management apparatus to the store membership management apparatus is set as information being part of user information from which information that can identify an individual has been excluded. Accordingly, the confidentiality can be improved.

The example illustrated in FIG. 12 indicates the content of changes from the membership registration process according to the first embodiment, but can also be applied to the membership registration process according to the second embodiment. Moreover, the above processes are performed by the appropriate components of the apparatuses. For example, the processes of Steps 2B and 6B are the processes to be performed by the information management unit 35 of the information management apparatus 3. The process of Step 3B is the process to be performed by the transmission unit 36 of the information management apparatus 3. Moreover, the process of Step 4B is the process to be performed by the information management unit 63 (63A) of the wireless terminal 5 (5A). Moreover, Steps 5B and 8B are the processes to be performed by the setting unit 46 (46A) of the store membership management apparatus 4 (4A).

### 4. Modification

The control unit 33 of the information management apparatus 3 can also delete user information on a user of the wireless terminal 5 (5A) from the user information table at the request of the wireless terminal 5 (5A). Moreover, if the user information is deleted from the user information table, the control unit 33 of the information management apparatus 3 can also transmit a notice to the effect that the deletion has been performed to the store membership management apparatus 4 (4A).

For example, the information management unit 63 (63A) of the wireless terminal 5 (5A) periodically transmits a user ID maintenance request including a user ID included in the setting data stored in its internal storage unit by the function of the membership card app. If periodically receiving the user ID maintenance request from the wireless terminal 5 (5A), the control unit 33 of the information management apparatus 3 does not delete the user information set in the user information table and, if a period during which the user ID maintenance request is not received elapses for a predetermined time, deletes the user information set in the user information table. The control unit 33 then transmits deletion information including the deleted user ID to the store membership management apparatus 4 (4A). If receiving the deletion information, the setting unit 46 (46A) of the store membership management apparatus 4 (4A) deletes user information corresponding to the user ID included in the deletion information from the member information table. By doing so, even if membership is registered in a plurality of membership services respectively offered by a plurality of member stores, the membership registration can be collectively deleted.

Moreover, the control unit 33 of the information management apparatus 3 may be set to include store information in accordance with the location of the wireless terminal 5 (5A) as the setting data of the membership card app. Specifically, the control unit 56 (56A) of the wireless terminal 5 (5A) transmits to the information management apparatus 3 a program request including the location information of the wireless terminal 5 (5A). The control unit 33 of the information management apparatus 3 creates the program data of the membership card app including in the setting data the store information in accordance with the location information included in program data and transmits the program data to the wireless terminal 5 (5A). The store information includes image data of a member store, a member ID, and location data as illustrated in FIG. 5. For example, the control unit 33 of the information management apparatus 3 selects a predetermined number of pieces of store information in descending order of distance of a store location from the location information of the wireless terminal 5 (5A) and includes the store information in the setting data. By doing so, the membership card app customized in accordance with the location of the wireless terminal 5 (5A) can be executed.

Moreover, the membership card app has a function of adding new store information. The control unit 56 (56A) of the wireless terminal 5 (5A) transmits a store information request including the location information of the wireless terminal 5 (5A). The control unit 33 of the information management apparatus 3 transmits to the wireless terminal 5 (5A) store information in accordance with the location information included in the store information request. The wireless terminal 5 (5A) adds the store information transmitted from the information management apparatus 3 to the setting data and accordingly is enabled to select a new membership card image.

Moreover, in the embodiments, the information management unit 63 (63A) of the wireless terminal 5 (5A) is set to make a membership registration request when the wireless terminal 5 (5A) enters the communication area of the wireless communication apparatus. However, the embodiments are not limited to this. For example, the information management unit 63 (63A) can also make a membership registration request together with a user registration request when the user first activates the membership card app.

Moreover, when the user of the wireless terminal 5A selects the membership card image 81 in the state where the display screen 71 illustrated in FIG. 6A is displayed on the display unit 52, if the wireless terminal 5A has entered the communication area of the wireless LAN access point 2, the information management unit 63A can also transmit to the store membership management apparatus 4A a membership registration request including the first store member ID set as the unset member ID.

### 5. Effects

As described above, the membership registration system 1 (1A) according to the embodiments includes the information management apparatus 3 and the store membership management apparatus 4 (4A). In the information management apparatus 3, user information being information on a user of the wireless terminal 5 (5A) is stored in the user information DB 32 (an example of a user information storage unit) and, if the store membership management apparatus 4 (4A) requests to transmit the user information, the transmission unit 36 (an example of a transmission unit) transmits user information in accordance with the transmission request to the user information DB 32. Moreover, in the store membership management apparatus 4 (4A), member information of a membership service offered by a store is stored in the membership DB 42 (an example of a store membership management storage unit) and, if the wireless terminal 5 (5A) makes a membership registration request, the setting unit 46 (46A) (an example of a setting unit) transmits to the information management apparatus 3 the transmission request of user information corresponding to the user of the wireless terminal 5 (5A), associates the user information acquired from the information management apparatus 3 with a member. ID and sets them as member information in the membership DB 42.

With such a configuration, the process of application for membership in a membership service can be performed while saving users time and trouble. Moreover, a store side does not need either to manually register user information in the membership DB 42.

Moreover, in the store membership management apparatus 4, if the wireless terminal 5 makes a membership registration request, the setting unit 46 (an allocation unit) allocates a new member ID of a membership service to a user of the wireless terminal 5, and the setting unit 46 associates the user information acquired from the information management apparatus 3 with the new member ID and sets them in the membership DB 42 as well as returns the new member ID to the wireless terminal 5 (5A).

Such a configuration enables automatic allocation of a new member ID of a membership service to a user of the wireless terminal 5 and accordingly there is no need to prepare a possible number of member IDs to be registered in advance and is neither need to manage the member IDs when prepared in advance.

Moreover, the membership registration request from the wireless terminal 5A includes an unset member ID as member information in the membership DB 42 and, if the wireless terminal 5A makes the membership registration request, the setting unit 46A associates the user information acquired from the membership registration request with the unset member ID included in the membership registration request and sets them in the membership DB 42.

With such a configuration, the wireless terminal 5A transmits the unset member ID and accordingly the store membership management apparatus 4A does not need to allocate a new member ID and the process load can be reduced. In addition, if there is a plurality of the information management apparatuses 3, the unset member ID is set as an ID that can be distinguished among the information management apparatuses 3 and accordingly it is possible to easily grasp that the user information has been acquired from which information apparatus.

Moreover, the information management unit 35 (an example of a user ID issuance unit) issues a user ID to a user of the wireless terminal 5 (5A), and associates user information received from the wireless terminal 5 (5A) with the user ID to store them in the user information DB 32. The membership registration request of the wireless terminal 5 (5A) to the store membership management apparatus 4 (4A) includes the user ID. The setting unit 46 (46A) of the store membership management apparatus 4 (4A) acquires from the information management apparatus 3 the user information associated with the user ID included in the membership registration request as the user information corresponding to the user of the wireless terminal 5 (5A).

Such a configuration enables the store membership management apparatus 4 (4A) to acquire user information with a user ID with which a user of the wireless terminal 5 (5A) has registered his/her membership. Accordingly, the store membership management apparatus 4 (4A) does not need to separately prepare an ID to acquire the user information, and the process load can be reduced.

Moreover, the information management unit 35 issues a user ID and a dummy ID to a user of the wireless terminal 5 (5A) and associates user information received from the wireless terminal 5 (5A) with the user ID and dummy ID to store them in the user information DB 32. The membership registration request of the wireless terminal 5 (5A) to the store membership management apparatus 4 (4A) includes the dummy user ID. The setting unit 46 (46A) of the store membership management apparatus 4 (4A) acquires the user information associated with the dummy user ID included in the membership registration request as the user information corresponding to the user of the wireless terminal 5 (5A) from the information management apparatus 3.

With such a configuration, an ID that the store membership management apparatus 4 (4A) transmits and receives to and from the wireless terminal 5 (5A) and the information management apparatus 3 is not a user ID but a dummy ID. Accordingly, it becomes possible to register membership without allowing a member store side that manages the store membership management apparatus 4 (4A) to know the user ID managed by the information management apparatus 3.

Moreover, in the information management apparatus 3 (an example of a program distribution apparatus), the transmission unit 36 (an example of a program distribution unit) distributes the program data of the membership card app (an example of data on the store membership program) to the wireless terminal 5 (5A). The program of the membership card app causes the wireless terminal 5 (5A) to function as the information management unit 63 (an example of a transmission unit) that transmits a membership registration request of a user of the wireless terminal 5 (5A) to the store membership management apparatus 4 (4A) and stores a member ID allocated to the user of the wireless terminal 5 (5A) as the setting data in the storage unit 54 (an example of a store membership management storage unit), a conversion unit 62 (an example of a conversion unit) that converts the member ID stored in the storage unit 54 into a barcode, and the display control unit 61 (an example of a display control unit) that displays the barcode converted by the conversion unit 62 on the display unit 52 of the wireless terminal 5 (5A).

With such a configuration, the barcode facilitates application to a store that offers a membership card. The two-dimensional barcode 85 has been described as the example of the barcode. However, the barcode may be a one-dimensional barcode.

Moreover, the membership registration system 1 (1A) according to the embodiments includes the wireless LAN access point 2 or an NFC device (an example of a communication apparatus), which is placed in a store that offers a membership service. In the store membership management apparatus 4 (4A), the determination unit 48 (an example of a determination unit) determines whether or not the membership registration request was made by the wireless terminal 5 (5A) via the wireless LAN access point 2 or the NFC device. Moreover, if the membership registration request was made via the wireless LAN access point 2 or the NFC device, the setting unit 46 (46A) acquires user information corresponding to the user of the wireless terminal 5 (5A) from the information management apparatus 3 and associates the acquired user information with a member ID to set them in the membership DB 42.

With such a configuration, the user of the wireless terminal 5 (5A) comes to the store where he/she receives the provision of the membership service, which enables membership registration. Moreover, his/her membership can be registered only from the store that offers the membership service and accordingly unnecessary membership registration can be prevented.

An aspect of embodiments can provide a membership registration system and a membership registration method that can perform a process of application for membership in a membership service offered by a store without placing a burden on a user.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A membership registration system comprising:
an information management apparatus; and
a store membership management apparatus, wherein
the information management apparatus including
a storage processing unit configured to store user information in a user information storage unit,
a transmission unit configured to transmit, when the store membership management apparatus requests transmission of user information, the user information according to the transmission request to the store membership management apparatus,
the store membership management apparatus including
a store membership management storage unit configured to store member information of a membership service offered by a store, and
a setting unit configured to transmit, when the terminal apparatus requests membership registration of a user, a transmission request of user information corresponding to the user of a terminal apparatus to the information management apparatus, and to set the user information acquired from the information management apparatus in association with a member ID as member information in the store membership storage unit.

2. The membership registration system according to claim 1, wherein
the store membership management apparatus includes an allocation unit configured to allocate a new member ID of the membership service to the user of the terminal apparatus when the terminal apparatus requests the membership registration, and
the setting unit sets the user information acquired from the information management apparatus in association with the new member ID in the store membership management storage unit and returns the new member ID to the terminal apparatus.

3. The membership registration system according to claim 1, wherein
the membership registration request includes an unset member ID as member information in the store membership management storage unit, and
the setting unit sets, when the terminal apparatus requests the membership registration, the user information acquired from the information management apparatus in association with an unset member ID included in the membership registration request in the store membership management storage unit.

4. The membership registration system according to claim 1, wherein
the information management apparatus includes a user ID issuance unit configured to issue a user ID to the user of the terminal apparatus,
the storage processing unit stores the user information received from the terminal apparatus in association with the user ID in the user information storage unit,
the membership registration request includes the user ID, and
the setting unit acquires from the information management apparatus the user information associated with the user ID included in the membership registration request as user information corresponding to the user of the terminal apparatus.

5. The membership registration system according to claim 1, wherein
the information management apparatus includes a user ID issuance unit configured to issue a user ID and a dummy ID to the user of the terminal apparatus,
the storage processing unit stores the user information received from the terminal apparatus in association with the user ID and the dummy ID in the user information storage unit,
the membership registration request includes the dummy user ID, and
the setting unit acquires from the information management apparatus the user information associated with the dummy user ID included in the membership registration request as user information corresponding to the user of the terminal apparatus.

6. The membership registration system according to claim 1, further comprising a communication apparatus placed in the store offering the membership service, wherein
the store membership management apparatus includes a determination unit configured to determine whether or not the membership registration request is made by the terminal apparatus via the communication apparatus, and
the setting unit, when the membership registration request is made via the communication apparatus, acquires the user information corresponding to the user of the terminal apparatus from the information management apparatus and sets the acquired user information in association with the member ID in the store membership management storage unit.

7. A non-transitory computer readable storage medium containing program instructions for providing information, wherein execution of the program instructions by one or more processors of a computer system causes the one or more processors to perform:
transmitting a membership registration request of a user to a store membership management apparatus;
storing a member ID allocated to the user in a store membership management storage unit;
converting the member ID stored in the store membership management storage unit into a barcode; and
displaying the converted barcode.

8. A membership registration method for registering member information of a membership service offered by a store, comprising:
storing, by an information management apparatus, user information in a user information storage unit,
transmitting, by a store membership management apparatus, to the information management apparatus a transmission request of user information corresponding to a user of a terminal apparatus when the terminal apparatus requests membership registration,
transmitting, by the information management apparatus, to the store membership management apparatus the user information in accordance with the transmission request from the store membership management apparatus, and
setting, by the store membership management apparatus, the user information acquired from the information management apparatus in association with a member ID as member information in a store membership management storage unit.

9. The membership registration method according to claim 8, further comprising:
allocating, by the store membership management apparatus, a new member ID of the membership service to the user of the terminal apparatus when the terminal apparatus requests the membership registration,
wherein the setting includes setting the user information acquired from the information management apparatus in association with the new member ID in the store membership management storage unit and returns the new member ID to the terminal apparatus.

10. The membership registration method according to claim 8, wherein
the membership registration request includes an unset member ID as member information in the store membership management storage unit, and
the setting includes setting, when the terminal apparatus requests the membership registration, the user information acquired from the information management apparatus in association with an unset member ID included in the membership registration request in the store membership management storage unit.

11. The membership registration method according to claim 8, further comprising:
issuing, the information management apparatus, a user ID to the user of the terminal apparatus,
wherein the storing includes storing the user information received from the terminal apparatus in association with the user ID in the user information storage unit,
the membership registration request includes the user ID, and
the setting includes acquiring from the information management apparatus the user information associated with the user ID included in the membership registration request as user information corresponding to the user of the terminal apparatus.

12. The membership registration method according to claim 8, further comprising:
issuing, by the information management apparatus, a user ID and a dummy ID to the user of the terminal apparatus,
the storing includes storing the user information received from the terminal apparatus in association with the user ID and the dummy ID in the user information storage unit,
the membership registration request includes the dummy user ID, and
the setting includes acquiring from the information management apparatus the user information associated with the dummy user ID included in the membership registration request as user information corresponding to the user of the terminal apparatus.

13. The membership registration method according to claim 8, further comprising:
determining, by the store membership management apparatus, whether or not the membership registration request is made by the terminal apparatus via a communication apparatus,
wherein the setting includes acquiring, when the membership registration request is made via the communication apparatus, the user information corresponding to the user of the terminal apparatus from the information management apparatus and setting the acquired user information in association with the member ID in the store membership management storage unit.
